(19) United States
(12) Patent Application Publication
(10) Pub. No.: US 2008/0091525 A1
(43) Pub. Date: Apr. 17, 2008

(54) Virtual online community with geographically targeted advertising

(76) Inventor: Laurent Kretz, New York, NY (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 11/580,725

(22) Filed: Oct. 13, 2006

(51) Int. Cl. G06Q 30/00; G06Q 10/00; G01C 21/34

(52) U.S. Cl. 705/14; 705/5; 705/6

(57) ABSTRACT

A web-based virtual community allows members to know who is sharing their commute or travel and find out about their personal or professional interests. The community provides them a tool to efficiently use their commute time for social and professional networking or connect with people in their area. The community provides an audience for advertisers to efficiently target their local customers inside the catchments area.

### FIELD OF THE INVENTION

The present invention related to the Internet, and more particularly to facilitating a virtual online traveler community and serving advertisements to users of the virtual online community.

### BACKGROUND

With the recent spread of the Internet, community online services have steadily grown over the past few years with an increasing popularity. Among community online services, the development of “Social Networking” websites is particularly noticeable. Most such websites allow users to connect to other individuals along defined common areas of interest, whether professional, hobbies, romance, etc. However, no websites offer features to easily enable people to browse, get to know and possibly meet other users who travel by common rail or metropolitan train networks.

Even if the content and the general purpose of the service differ, these Social Networking websites are mostly built on a similar business model. Generally the services are built upon premium fees or, more commonly, free access portals with possible subscription to ancillary features, voluntary contributions or subscription to premium services. As far as the free portals are concerned, the aim is to build a critical mass of loyal users in order to get a significant advertising exposure and thus generate contextual advertising revenue. However, Social Networking online services commonly employ banner or contextual advertising, while local advertising capabilities have yet to be introduced. This is mainly because there is little technical possibilities today to guarantee a locally targeted advertisement distribution.

Local advertisement has not been transposed to the Internet for technical and demographical reasons. The ad serving technology had not reached its maturity and the technical conception of websites has yet to optimize to receive complex ad serving rules. The local targeting techniques employed nowadays are based on IP recognition, to deliver the correspondent advertisement (text or creative). IP based targeting has shown its limits with for example generic IPs (that can not be localized) or IPs hidden by proxies, that simply do not allow for high accuracy. The greatest obstacle nowadays is the fact that the most precise level of targeting of IP addresses is a city, the levels above being global, country, and state.

### SUMMARY

The system of the invention indexes in its database of transport networks (group of lines), and allows users to create trips by reference to those networks. Each station or stop, as applicable, has a unique ID, and a line is described by a string of these unique IDs such that each trip is a string of station IDs that can be matched to another user's string. The user is provided with information regarding matching users so as to allow for interaction with those users. For each search inquiry, the advertising system launches a request to the client database to extract the advertisement that corresponds to the unique station ID used to define the scope of the search (by reference to the station-in and station-out of the user). In one embodiment, the networks are of railroad transportation, such as subway and train lines. In other embodiments, the networks are of other transportation systems, which have regular stops, including airlines, bus lines, and ferry systems, both public and private.

The system of the invention offers advertisers a unique way to transpose the offline urban or subway specific targeting to an online level. Every station, area, city or country referenced in the database can be targeted by an advertiser. The system can transpose the value of geographical places to an online level. As the community expands and covers more cities, the system's advertisement offer will allow a broader targeting, moving to a countrywide range, or even a worldwide range.

The system of the invention allows users to identify other users who share their commute or occasional trips and informs them of common interests related to such travel. The system is based on the indexation of all stations of railway networks, including subways and trains. From the basis of the string of stations that a line of a specific network represents, a matching engine elaborates a response to users' requests providing exact or closest matches which correspond to the user's submitted trip.

Stations are associated with zip codes, which are purchases. A group of zip codes represents a district, a group of districts represents a city, a group of cities represents a country and so forth. By buying a specific station, group of stations, zip code (that can include several stations), city or country, the advertiser specifically targets the users that may live or work proximate to and that commute on the included stations.

### BRIEF DESCRIPTION OF THE DRAWINGS

FIG. 1 is a representation of a sample rail network;

FIG. 2 is a representation of categories of railroad networks;

FIG. 3 is a schematic representation of the rail networks presented in FIG. 1 as indexed in the SubMate database;

FIG. 4 is a schematic representation of the user trip database;

FIG. 5 describe the unique coupling between a line and its sequence of stations;

FIG. 6 presents the workflow of interaction between the user and the system for saving a trip;

FIG. 7 is the representation of the system form for saving a trip;

FIG. 8 presents the standard display of a user trip;

FIG. 9 presents the different options for a user to launch a search;

FIG. 10 is a schema presenting the matching logic of the engine;

FIG. 11 illustrates the matching algorithm of the virtual community;

FIG. 12 illustrates the database browsing when a search request is launched.

FIG. 13 illustrates the result dataset creation;

FIG. 14 illustrates customizing the results to user needs;

FIG. 15 illustrates the results display screen;

FIG. 16 is the scope of the advertising solution of the system;

FIG. 17 presents the method of indexing the stations at the four targeting advertisement levels;

FIG. 18 shows the available targeting for the advertisers in the system;

FIG. 19 illustrates the filtering of the user search results dataset to match the existing ads;

FIG. 20 illustrates the customer catchment area possibilities for an advertiser; and

FIG. 21 is a flowchart illustrating the process for selecting advertisement for display.

### DETAILED DESCRIPTION

The structure and operation of a system of the invention will now be discussed by reference to a virtual community of railroad network passengers and corresponding advertisement services. However, as may be appreciated, the invention is applicable to any transportation network having regular stops, such as airlines, bus, ferry, and express bus service, both public and private. For the purposes of the discussion that follows, the term “Railroad networks” is intended to mean all public or private transportation methods. In such context, such transportation methods include, but are not limited to, train, subways, metros, tubes, rapid trains, urban, suburban and inter-urban trains.

An example virtual community in accordance with the present invention refers to train stops, or stations, in facilitating interaction between interested users. A train or subway network is usually composed of various lines, composed of a sequence of stations. A network can include 1 to several lines. Each line is usually bi-directional, some networks include loop lines. Sequence of stations include stations only used by one line, and stations used by several lines. The latter is called a hub station.

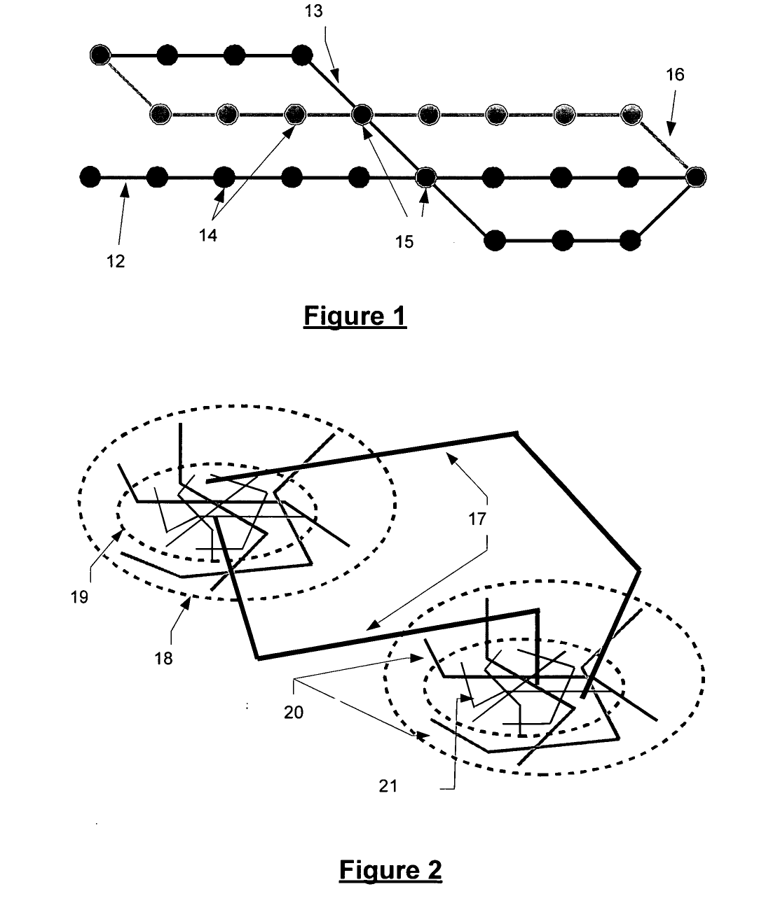

All existing networks have unique lines, identified either by their name, their color, or their direction on the network topology chart. FIG. 1 illustrates an example rail transport network. The categorization of networks for the lines in FIG. 1 is presented in FIG. 2. Networks can be urban 19, 21, such as regular subways, sub-urban 18, 20, linking the suburbs to the city center inside the metropolitan area, or inter-urban 17, linking different cities and metropolitan areas. The main difference on a schematic basis between the different networks is the distance between two continuous stations. The distance between two continuous stations is increased from a subway network 19, 21 to a sub-urban network 18, 20, and from a sub-urban network 18, 20 to an inter-city network 17.

Referring to FIG. 1, commuters employ transportation services to travel on a regular or occasional basis along network lines to move from point A to point B. By such travel, they cross a number of stations, creating a unique sequence of stations (hereunder a trip). One commuter can be assigned with multiple trips. Included in this sequence can be standard stations 14 (only used by one line 12, 16) as well as hub stations 15 (used by multiple lines 12, 13, 16).

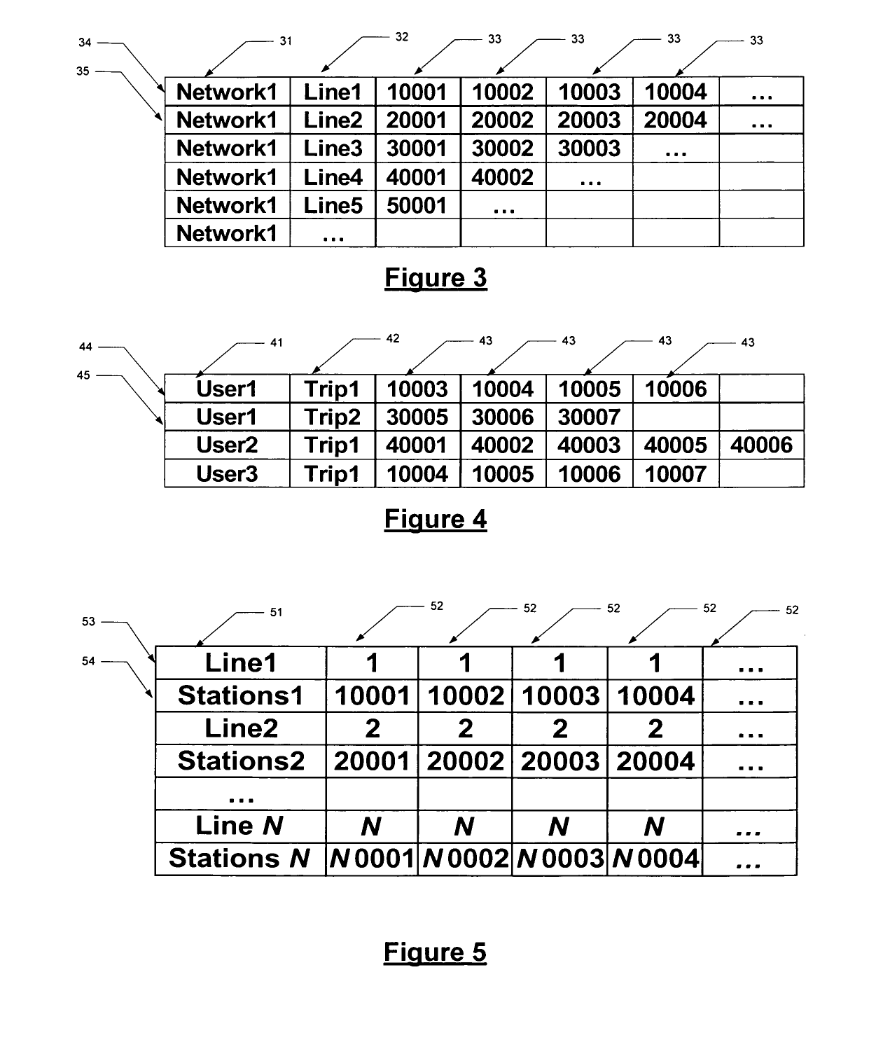

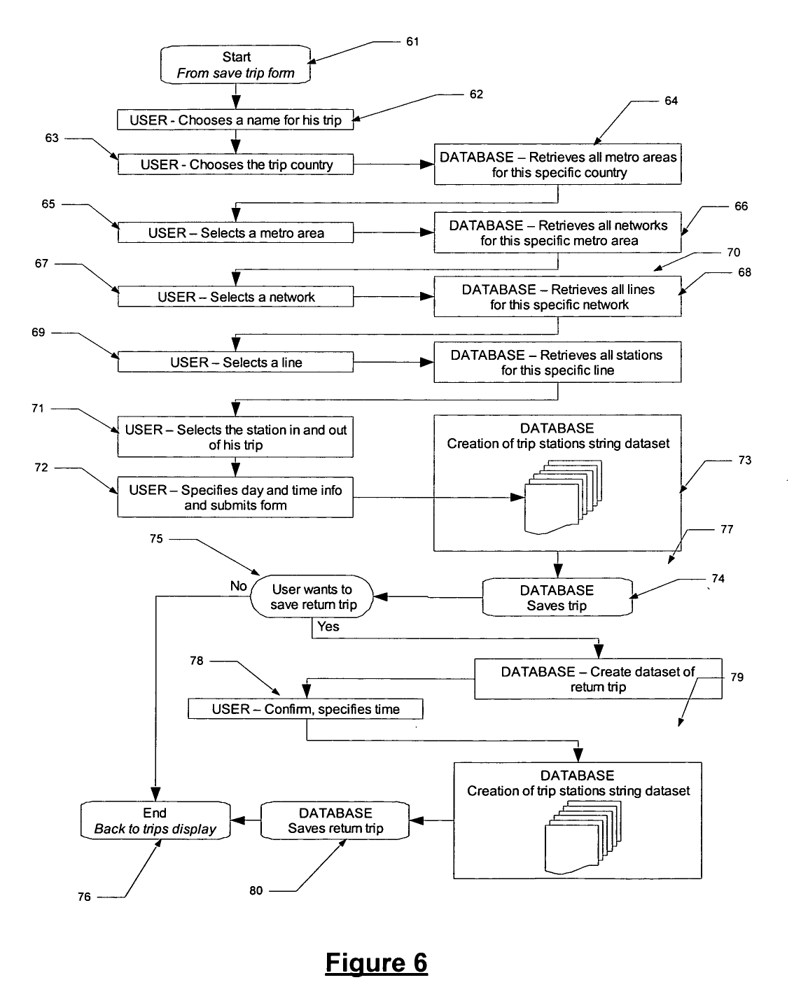

To index the subway and train networks, each station is assigned a unique identifier (hereafter referred as “StationID”) as shown in FIG. 3. The hierarchical classification used by the invention is as follows: a station is part of a line; a line is enclosed in a (rail) network; a network is set in a metropolitan area (hereunder referred as “Metro Area”) and a Metro Area belongs to a country. For instance, the New York MTA subway belongs to the city of New York, as an “urban network”. The LIRR (Long Island RailRoad) belongs to the metropolitan area of New York, as a “sub-urban network”. The whole city belongs to the country United States. In a similar manner, the Amtrak lines linking New York City to Philadelphia and Washington only belong to the country category, as a “inter-urban network”.

Inside a network indexation, as described in FIG. 5, lines are identified by a single ID 51. For each line, stations are numbered by an ascending unique IDs 52. The sequence may be ascending for one direction, or descending for the opposite. In both cases, the real sequence of stations is reproduced as a unique string of unique StationIDs 54. Some of those StationIDs are shared by a plurality of lines, in the case of hub stations.

In one embodiment, the system receives travel information to identify the stations associated with each user's travel. The system allows a user to submit a daily, a regular, or an occasional trip using the indexed networks. The trip represents a commute or travel between two specific stations. By extending this string to different lines, the system is able to define the commute of a specific user, including when the user is traveling along different lines, i.e., switching trains (subway, sub-urban and inter-urban combined) to go from point A to point B. In other terms, the system allows the user, in a single sequence record, to save multiple segments. This functionality is provided by concatenating the strings of StationIDs that are associated with each section of a user's commute.

For example, a New Yorker leaving from Westchester to Grand Central on the Metro North Railroad, then switching to the 6^{th} line up to Lexington and 59^{th} Street, catching a connection on the N line down to Times Square who is saving a trip on the system, would save only one string of stations representing trip from the submitted entry point (Westchester) on the public transportation system to the submitted exit point (Time Square).

As shown in FIG. 4 and explained above, in addition to the entry and exit stations (hereunder referred as “Station In” and “Station Out”, respectively) the user trip StationID string 44, 45 includes all stations that the user transports through. Since some stations are used by various subway or train lines, and some lines use the same path but do not stop at the same stations (e.g., one being express, the other being local), in addition to the above described station indexing using StationID, the system employs a unique combination of a station and a line. For instance, if station A is used by lines X and Y, station A would have a unique StationID, but the combination of station A and line X, as well as the combination of station A and line Y, would also be unique. This allows the system to recognize that two users passing by the same station but on different lines could not physically meet. FIG. 5 illustrates the coupling between a station 54 and its lines 53, in the case of unique lines passing by the specific station, as well as in the case of multiple lines passing by the specific station.

Users submit trip data by interacting with forms of the system website. In the save trip form illustrated in FIG. 7, a user starts by entering a trip name 83, which identifies the trip. The second step is identifying the country in which the user is located. In one embodiment, the system employs a locator based on user's internet access provider to auto-populate the field 84. Once the county field 84 is loaded, the corresponding Metro Areas are loaded, i.e., the Metro Areas that correspond to the scope of the identified country. The user then chooses the Metro Area from the selection box 85. Based on the selected Metro Area, the system will load networks associated with this Metro Area. The user chooses a railroad network from the selection available 86. Choosing a railroad network will automatically load the lines included in the network in a selection box 87. The user finally selects a line as well as entry 88 and exit 89 stations, the stations being loaded into the selection boxes in response to the selection of the line. At this point, as shown on FIG. 7, the user selects a trip time 91 and day 90. From the information submitted by the user, the system creates at least four entries in the users' trips database: the line unique id, the entry and exit station unique StationIDs, and the sequence of stations the user is passing through, which is composed of a string of StationIDs. In some embodiments, if the user switches lines during his trip, additional segments are registered in the user trip by following the steps outlined above.

Finally, the user is provided the option of saving a return trip (not shown), which would be applicable if the initial trip is a daily commute, whereby the user travels in the inverse direction at a later time. Accordingly, if the user requests such reverse trip, the system reverses the string of StationIDs of the first trip, and suggests a return time. If accepted by the user, this reverse trip is saved as a second trip associated with the user.

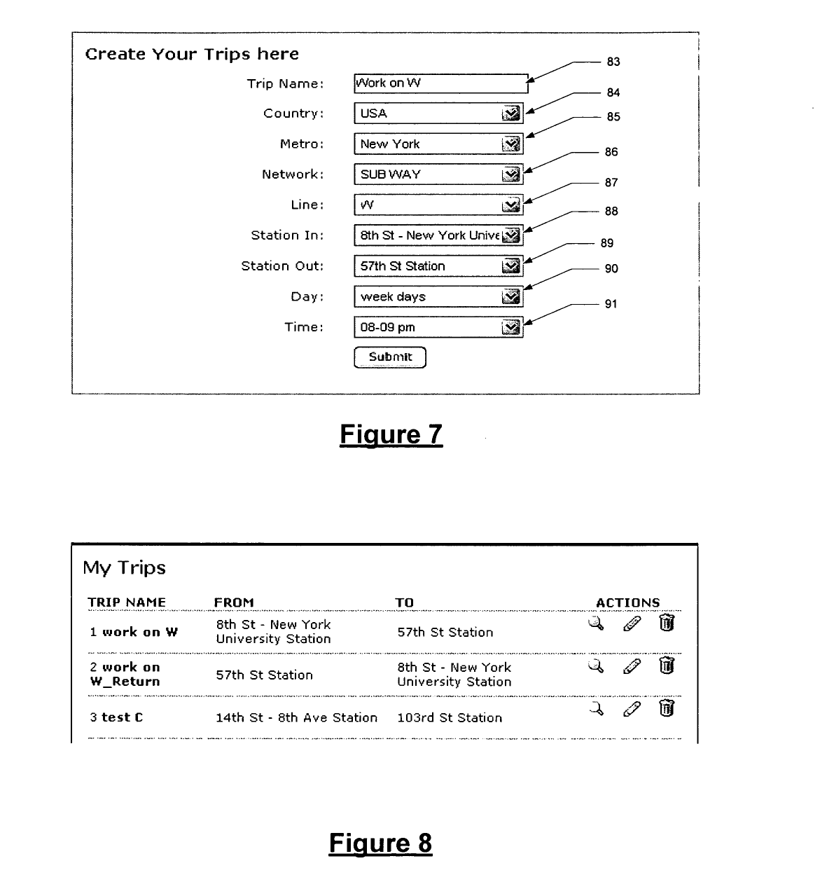

FIG. 8 illustrates a display screen providing saved user trips. To launch a search for other users with common travel, similar to the saved user trips, users are provided with several options. As shown on FIG. 9 users can access the search function from a homepage 94, from the search form 95, or from a form presenting saved trips 96. In one embodiment, the system is designed so that the user doesn't have to fill out a search form, but instead can launch the search directly from his saved trips.

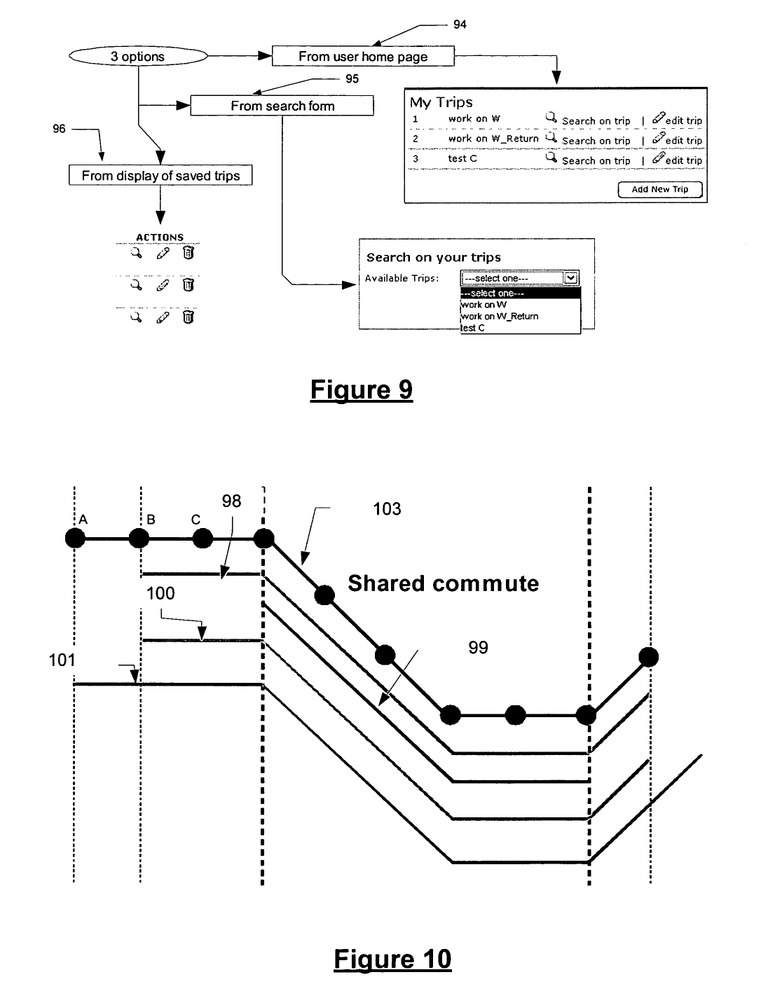

The search allows users to identify who is sharing whole or part of their commute, while allowing advertisers to efficiently reach their target audience. In a first example interaction, a user employing the system would like to know who shares his commute. Specifically, the user would like to know who is entering at his station, who is exiting at the same station, who is entering and exiting during his trip, or who is entering before and exiting after him. As illustrated in FIG. 10, if a user, User1 for the following explanation, launches a search, the goal will be achieved if included in the search results are User2 (whose commute 99 is enclosed in User1's 98, i.e., enters after, and exits before, User1), User3 (which is considered a “perfect match” by sharing the same trip 100), and finally User4 (whose trip 101 enters before and exits after User1's 98).

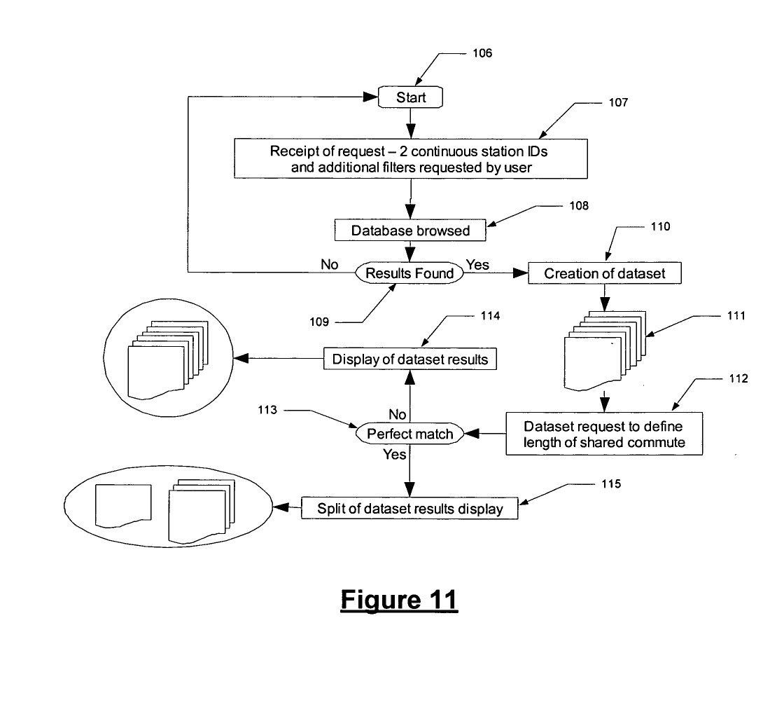

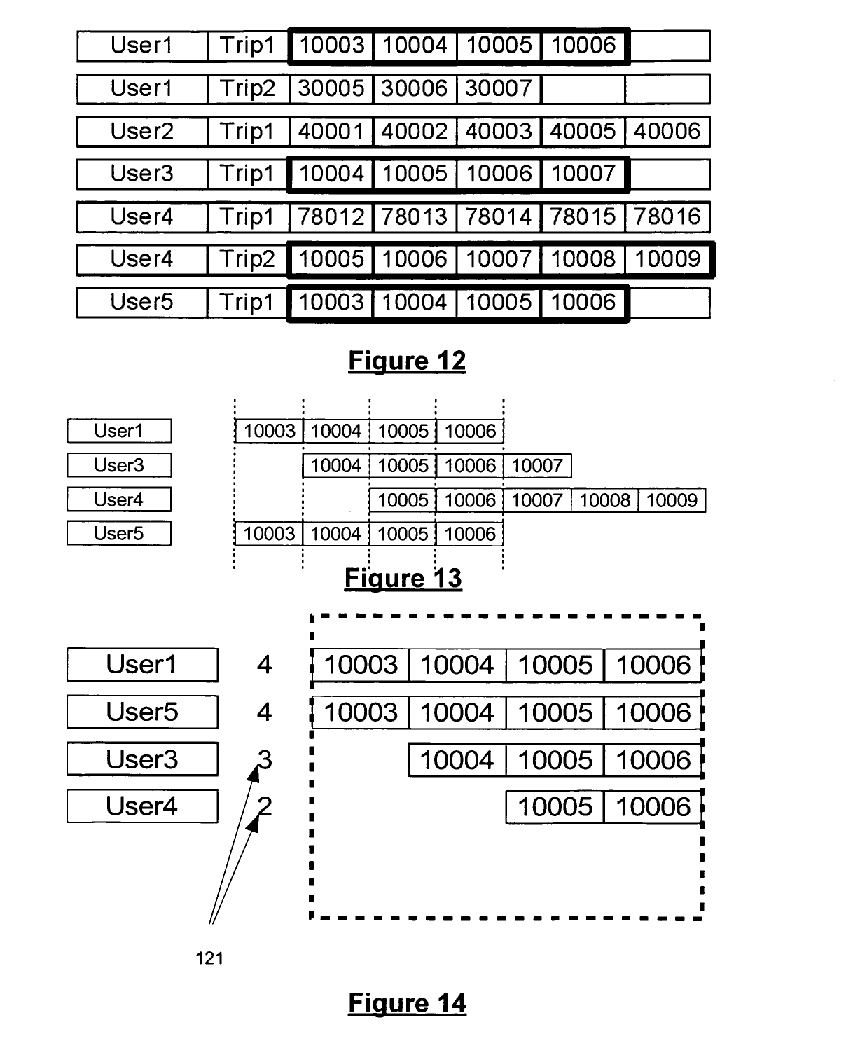

Preferably, no direction information is necessary when saving a trip since the system automatically detects the direction by analyzing the StationID sequence and detecting continuous stations. As shown in FIG. 11, if stations were designated as A, B, C, etc., the system would identify the direction of the trip by a set of continuous StationID pairs. In this example, having a string of B-C StationIDs, or C-B StationIDs would define the direction of the trip. Once User1 has launched a search, the search algorithm will operate a request in the database to build the dataset and display the results. Described from FIG. 12 to FIG. 14 are the different steps of the search process and the dataset creation.

The system responds to a request by repeatedly performing a query that selects all entries of the database that include at least one section (i.e. 2 continuous stations for the direction, as explained above) of ordered StationIDs from the trip StationID sequence of the user launching the search. This first step of the operation is presented in FIG. 12, namely, browsing the database for station pairs 107. Additional filters are also taken into account, such as the trip's time or day. The loop will take each StationID pair in the sequence and repeat the operation by browsing the database searching for the same pair 108. For example, if the trip goes from station A to station E passing by the stations B, C, and D, the loop will test the database with the sections A-B, B-C, C-D and D-E.

As illustrated by FIG. 13, the dataset is created after this first operation 110. In the example, the dataset contains all users (User2, User3, . . . , UserN) sharing at least one section (2 continuous stations) with User1, who request the search. The system now determines how many sections are shared between User1, requesting the search, and the uses included in the result dataset 112. The system determines whether the match is perfect or partial 113. This determination is by exacting a test loop between User1's trip and each trip of the users contained in the dataset. For each test, the number of sections, i.e. continuous stations, common between the UserN and User1 are stored. The dataset is sorted decreasingly by this number, as described in FIG. 14. In other terms, the dataset will present the users sharing the most common stations 115, prior to those sharing less common stations 114. The final task in the sorting operation is to determine which of the top results of the dataset are sharing the exact same entry station and exit station so as to maximize relevancy. For example, as shown on FIG. 14, where User3 and User4 do have the maximum number of common sections with User1 but User4 does not share the entry and exit station User4 is displayed at a lower position. The loop amongst the higher ranking results is the final step of the process, and will separate the “perfect matches” from the other results.

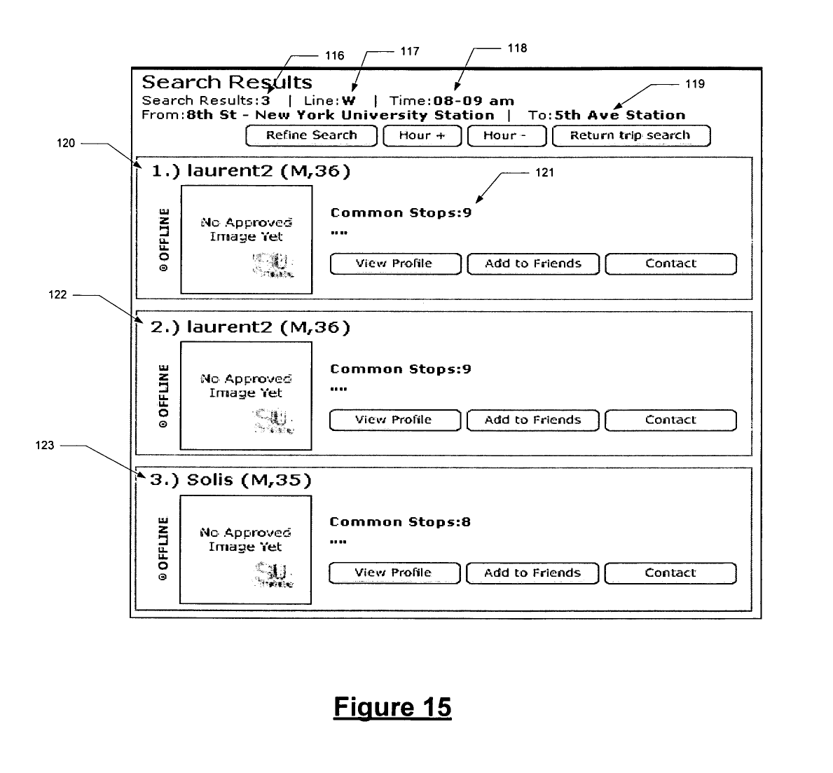

The results are displayed to User1, who requested the search, as shown on FIG. 15. As explained above, the displayed users are in a decreased order of the number of common stations shared. Preferably, the perfect matches will be presented higher up in the order of the results list.

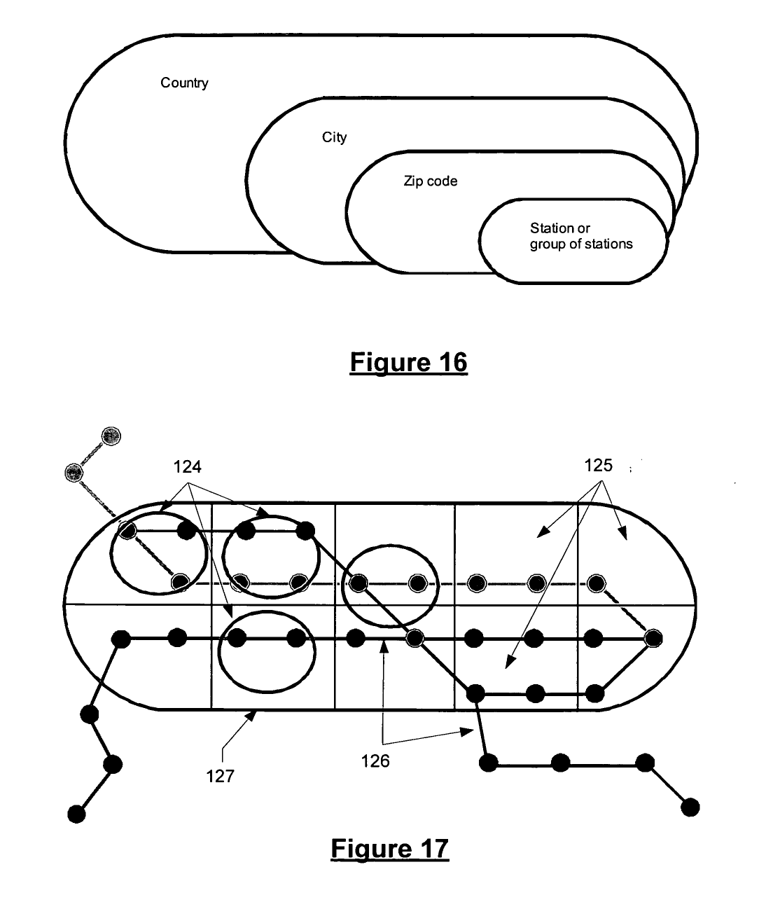

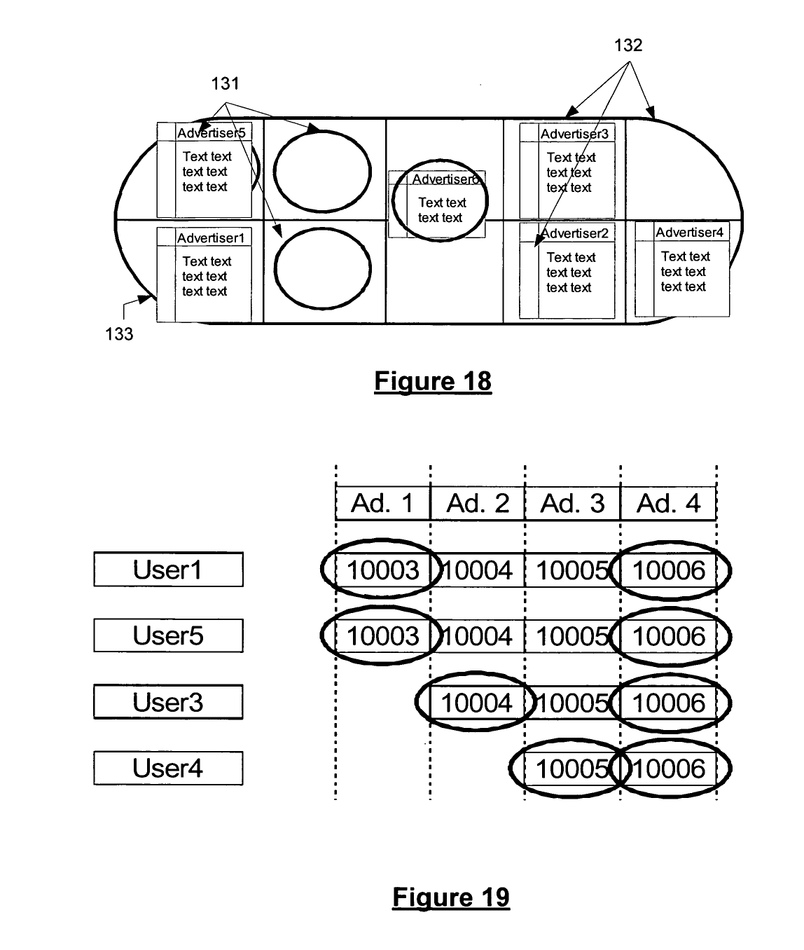

When presenting the screen of FIG. 15, the system incorporates advertiser messages, which are specifically targeted to the searching user by geographical data. The online advertisement solution of the system allows advertisers to reach their prospects on a closest geographical scope possible. In one embodiment, this geographical scope is based on a plurality of targeting levels which include: country, metropolitan area, city, zip code, train or subway station, or group of stations. These levels of geographical targeting are configured to cover relative user as shown in FIG. 16:
A country is the geographical space in which are enclosed one to several cities served by the system. For example, the United States of America are composed by a certain number of cities. From the advertiser perspective, buying an advertisement at the country level will cover all cities which the system services for this specific country. For instance, New York, Chicago and San Francisco are in the USA and therefore these three cities will compose the USA from an advertiser perspective.
Every place connected to a metropolitan area is considered part of this area by a metropolitan public transportation network (trains, subways and/or buses). For example New York City is composed of the five boroughs (Manhattan, Brooklyn, Queens, Bronx and Staten Island) as well as every district that has metropolitan area networks serving at least one station in New York City. In this case, New York City's metropolitan area also include New Jersey, Upstate New York, etc. Hence, an advertiser choosing to target a metropolitan area cam reach every commuter traveling in this metropolitan area.
A city area is the administrative definition of the system. By definition this city area is composed of various zip codes and districts. The system considers part of a city every place connected to the city by a metropolitan public transportation network (trains and/or buses). For example New York City is composed of only stations within the five boroughs (Manhattan, Brooklyn, Queens, Bronx and Staten Island).
As to zip codes, the systems adheres to the official geographic definition for a zip code. Every network station in the systems database is associated with its unique zip code. A zip code may be composed of one or more stations that are within the zip code's range.
A station or group of stations is the most precise level of targeting in the advertising system. A station or group of stations is considered to be inside a zip code area.

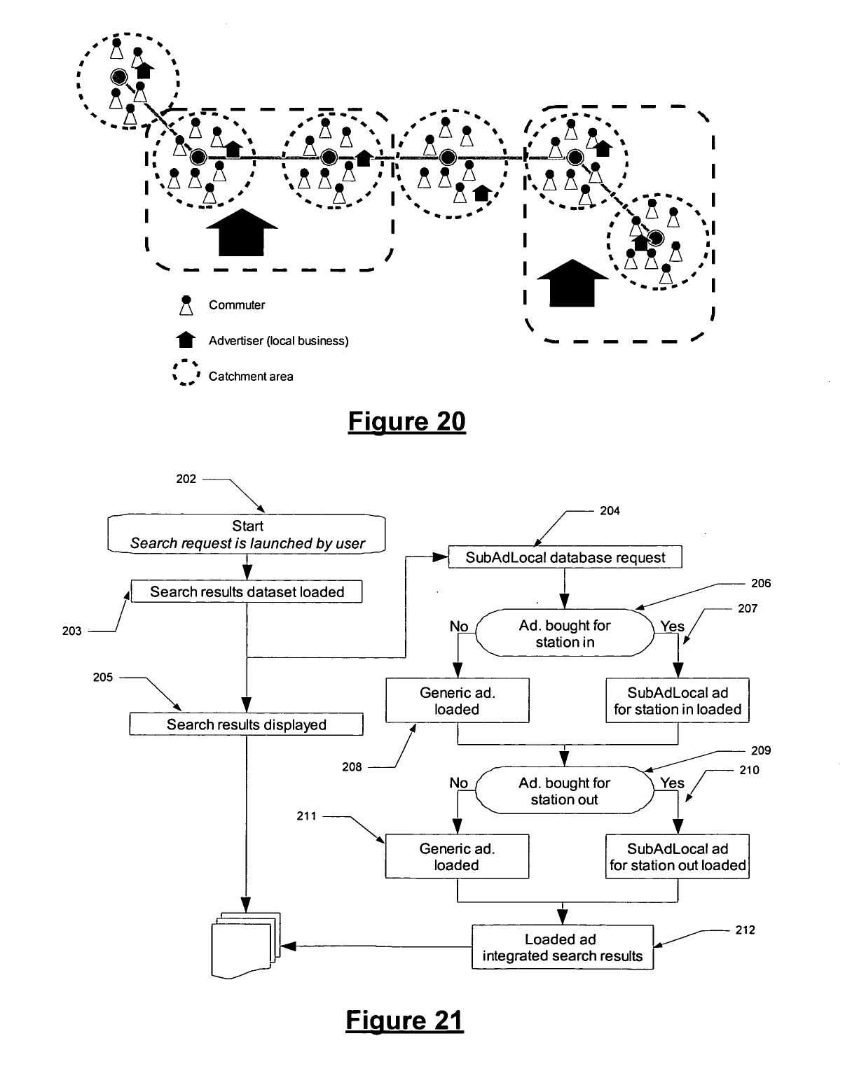

Advertisers may chose between one or more targeting levels, as discussed above, in order to precisely reach their audience. Every user in Submate's database has defined his trip. Therefore, the system can identify the station in and station out for each user. As shown on FIG. 19, advertisements are served by taking in consideration the dataset based on the user's trip. User 1 travels from station 10003 to station 10006, therefore, this user will only see advertisements for these two stations while he browses Submate. As seen on FIG. 20, the system allows any advertiser to target its intended audience combining data mining information from the user database with geographical data. Accordingly, the system can deliver advertisement only to relevant users and thereby reduce waste.

The system can adapt to the advertiser's geographical catchment area by choosing one of the available targeting levels. This technique allows the system to provide a service for any type of advertiser. For example a big corporation selling services or products nationwide will be able to target the largest possible audience, while the small local business can target users located in a neighborhood, district, or city. If there are no advertisers for a user's in and out stations, the system displays advertisements for the closest in and out stations that have advertisements attached to them. The following rules apply for a metropolitan area advertisement serving and are employed by the algorithm of FIG. 21:

| Priority | Case | Action |
|---|---|---|
| 1 | User's “in” and “out” stations have an advertisers | Serve ads for “in” and |
| | attached to them | “out” stations |
| 2 | One of the user's trip “in” or “out” stations has | Serve ad for station that |
| | an attached advertiser and the other has not | has an advertiser, serve |
| | | standard ad for the other |
| | | station |
| 3 | User's “in” and “out” stations do not have | Serve ad for the closest |
| | attached advertisers | station, in a range of two |
| | | stations away |
| 4 | User's “in” and “out” stations do not have | Serve ad for a citywide |
| | attached advertisers, and no advertiser in a range | advertiser |
| | of two stations | |
| 5 | User's “in” and “out” stations do not have | Serve ad for a countrywide |
| | attached advertisers, and no advertiser in a range | advertiser |
| | of two stations | |

In FIG. 21, the system's adserving is processed immediately after the user's search request is sent to the database. Once the search results dataset is loaded 203, there is enough information to browse the system's database to find matching ads for the request 204. Several rules apply for the advertisement display, which regulate the ad flow as the advertiser inventory can change at any given moment. These variable will affect the advertisement display processed in the database. The advertisement rules explained above are then used to identify the relevant advertisements. Specifically, the system searches for advertisement bought for a station-in 206. If an advertisement was purchased for the station-in, the ad is loaded 207. They system then searches for advertisement bought for a station-out 209. If an advertisement was purchased for the station-out, the system loads the purchased advertisement 210. All loaded advertisements are then integrated into the search results display and provided on the results screen 212. Once the database request has been processed, and after having applied the filtering rules for ad displaying, the advertisements are integrated to the search results display.

1. A method for providing local audience targeted advertising to online users of a virtual community, comprising:
receiving travel information including at least an origin and a destination from at least two users of a virtual community website;
parsing the received information from said at least two users to identify at least one travel stop associated with the received travel information for each user;
for each user from which information is received and parsed, storing the user information along with the corresponding at least one travel stop in a database record;
receiving a query from a searching user for disclosure of other users sharing at least one travel stop with the searching user;
querying the database for other users sharing travel stops with the searching user;
receiving at least one common stop identifier for a stop shared between the searching user and another user;
retrieving at least one advertisement corresponding to said at least one local stop identifier;
displaying user information for said another user on a webpage along with said retrieved advertisement;

2. The method of claim 1, further comprising transmitting information relation to a second user sharing at least one travel station with the user.

3. The method of claim 1, wherein said travel information further includes an identifier for a transportation line.

4. The method of claim 3, wherein said travel information further includes an identifier for an additional transportation line.

5. The method of claim 1, further comprising prompting the user to select an identifier for a transportation line associated with the received origin and destination information.

6. A method for providing a geographically specific advertisement, comprising:
facilitating an internet website which requires a user to provide accurate geographic location information so as to benefit from the services provided by the website; and
providing the website services to the user after receiving said geographical location information from said user, the services provided with integrated advertisement that are selected by reference to the geographic location information submitted by the user.

7. The method of claim 6, wherein said internet website is a virtual community of commuters.

8. The method of claim 7, wherein said website services include providing information regarding users that employ similar commuting resources as the user employing the website services.

9. The method of claim 8, wherein said similar commuting resources comprise sharing at least one station in traveling on a public transportation system.
